(19) United States
(12) Patent Application Publication
(10) Pub. No.: US 2017/0171349 A1
(43) Pub. Date: Jun. 15, 2017

(54) Method, Device and System for Transmitting Data

(71) Applicants: Le Holdings (Beijing) Co., Ltd., Beijing (CN); LeCloud Computing Co., Ltd., Beijing (CN)

(72) Inventors: Ming Li, Beijing (CN); Ruiqian Zhao, Beijing (CN)

(21) Appl. No.: 15/246,565

(22) Filed: Aug. 25, 2016

Related U.S. Application Data
(63) Continuation of application No. PCT/CN2016/089466, filed on Jul. 8, 2016.

(30) Foreign Application Priority Data
Dec. 14, 2015 (CN) 201510923477.1

(51) Int. Cl. H04L 29/08

(52) U.S. Cl. CPC H04L 67/325; H04L 67/1095; H04L 67/2842

(57) ABSTRACT

Disclosed are a method, an electronic device and a system for transmitting data. The method includes: obtaining transmission delay time of multiple data transmission paths between a cache server and a source server, wherein the transmission delay time are detected by the cache server; configuring data transmission path having the minimum transmission delay time as the shortest data transmission path between the cache server and the source server; sending configuration information of the shortest data transmission path to the cache server, so that data is transmitted between the cache server and the source server via the shortest data transmission path.

### CROSS REFERENCE TO RELATED APPLICATIONS

This application is a continuation of International Application No. PCT/CN2016/089466, filed on Jul. 8, 2016, which is based upon and claims priority to Chinese Patent Application No. 201510923477.1, filed on Dec. 14, 2015, the entire contents of all of which are incorporated herein by reference.

### TECHNICAL FIELD

The present disclosure relates to internet technologies, and more particularly, to a method, an electronic device and a system for transmitting data.

### BACKGROUND

The number of websites has significantly increased with the development of Internet technology. Among these websites, ones with enormous traffic flow usually use Content Delivery Networks (CDN) accelerating technology. By delivering data in websites source server to each cache server in a CDN, users can directly access to the cache server, in which users can access some cached data after DNS analysis and scheduling, thereby reducing network congestion of Internet and increasing response speed when users visit the websites. Client may directly transmit a request to the cache server for asking for a data. If the data exists in the cache server, the cache server will directly transmit the data to the client, otherwise the cache server will directly request the data from source server, then transmit the requested data to the client and store it in the meantime. A control center server selects a source server for the cache server for requesting the data. There are usually multiple data transmission paths between the cache server and the source server.

At present, control center server usually configures a fixed data transmission path for cache server, thus the cache server can transmit data to source server via the fixed data transmission path. However, transmission speed will be quite slow when the link status of fixed data transmission path is poor. Therefore, it is a great significance for control center server to determine the shortest data transmission path between a cache server and a source server. However, in the prior art, control center servers can't obtain link status of various date transmission paths by configuring fixed data transmission path for a cache server, causing that it is unable to determine the shortest data transmission path and improve data transmission speed.

### SUMMARY

The present disclosure provides a method, an electronic device and a system for transmitting data, which are used for solving a defect in the prior art that it is unable to determine the shortest data transmission path between a cache server and a source server and improve data transmission speed by a control center server.

In a first aspect, embodiments of the present disclosure provide a method for transmitting data, implemented by a server, including:

obtaining transmission delay time of multiple data transmission paths between a cache server and a source server, wherein the said transmission delay time are detected by the cache server;

configuring data transmission path having the minimum transmission delay time as the shortest data transmission path between the cache server and the source server;

sending configuration information of the shortest data transmission path to the cache server, so that data is transmitted between the cache server and the source server via the shortest data transmission path.

In a second aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for transmitting data mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to :

detect transmission delay time of multiple data transmission paths between a cache server and a source server,

send the said transmission delay time to a control center server, so that the control center server configures data transmission path having the minimum transmission delay time as the shortest data transmission path between the cache server and the source server;

receive configuration information of the shortest data transmission path from the control center; and

transmit data to the source server via the shortest data transmission path.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for transmitting data in accordance with some embodiments;

FIG. 2 is a flowchart of a method for transmitting data in accordance with some embodiments;

FIG. 3 is a block diagram illustrating a structure of a control center server in accordance with some embodiments;

FIG. 4 is a block diagram illustrating a structure of a cache server in accordance with some embodiments;

FIG. 5 is a block diagram illustrating a structure of another cache server in accordance with some embodiments;

FIG. 6 is a block diagram illustrating a system for transmitting data in accordance with some embodiments;

FIG. 7 is a block diagram illustrating an entity structure of a control center server in accordance with some embodiments; and

FIG. 8 is a block diagram of an electronic device which is configured to perform the methods for transmitting data in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

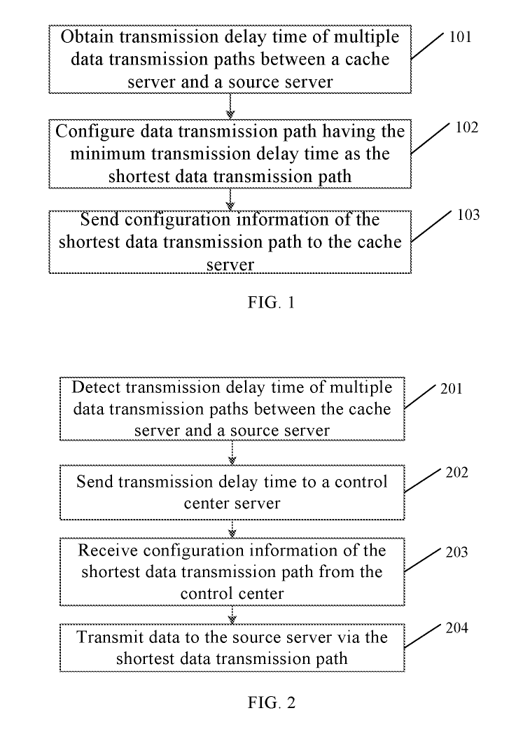

Embodiments of the present disclosure provide a method for transmitting data. The method can be applied in a control center server, as shown in FIG. 1, the method includes:

101. Obtain transmission delay time of multiple data transmission paths between a cache server and a source server, the said transmission delay time are detected by the cache server.

Among the transmission paths, the cache sever could send detection request packet to the source sever via the data transmission path and record the sent time. Then the cache sever could receive detection response packet returned by the source sever via the data transmission path and record receipt, where transmission delay time is a difference between the sent time and the receipt time.

For example, there are three data transmission paths: data transmission path1, data transmission path2 and data transmission path3 between a cache server and a source server. The cache server could send detection request packet to the source server via data transmission path1, data transmission path2 and data transmission path3 respectively and record sent time t1, sent time t2 and sent time t3 of detection request packet respectively. After that, the cache server could record receipt time T1, receipt time T2 and receipt time T3 when receives detection response packet returned by the source sever via data transmission path 1, data transmission path2 and data transmission path3 respectively. Transmission delay time corresponding to the three data transmission paths can be respectively described as the following equation: Δt1=T1−t1, Δt2=T2−t2 and Δt3=T3−t3.

For the embodiments of the present disclosure, the step 101 can be specifically described as obtaining transmission delay time between the various nodes, which are respectively corresponded to multiple data transmissions path between a cache server and a source server, the said transmission delay time between the various nodes are detected by the cache servers; and computing the said transmission delay time of multiple data transmission paths according to the said transmission delay time between the various nodes. Specifically, wherein computing the said transmission delay time of multiple data transmission paths according to the said transmission delay time between the various nodes includes: determining the sum of transmission delay time between the various nodes which are corresponded to each data transmission path as transmission delay time of each data transmission path.

For example, there are three nodes in the data transmission path1: a cache server, a node server1, a source server. Transmission delay time of the data transmission path1Δt1 can be described as the following equation: Δt1=Δt11+Δt12, where Δt11 is the transmission delay time between the cache server and the node server1, Δt12 is the transmission delay time between the node server1 and the source server.

For the embodiments of the present disclosure, by detecting transmission delay time of multiple data transmission paths between the cache server and the source server, link status of various data transmission paths can be available to the control central server and the shortest data transmission path can be determined, thereby data transmission speed can be increased.

102. Data transmission path having the minimum transmission delay time is configured as the shortest data transmission path.

Among them, the less transmission delay time of data transmission path, the better link status, the faster data transmission speed. It is able to ensure data transmission speed by configuring data transmission path having the minimum transmission delay time as the shortest data transmission path.

For example, there are three data transmission paths: data transmission path1, data transmission path2 and data transmission path3 between a cache server and a source serve, which correspond to transmission delay timeΔt1, Δt2 andΔt3 respectively. Δt1 is the minimum of Δt1, Δt2 and Δt3, so data transmission path1 can be configured as the shortest data transmission path between the cache server and the source server.

103. Configuration information of the shortest data transmission path is sent to the cache server.

Further, data can be transmitted between the cache server and the source server via the shortest data transmission path.

In the method for transmitting data provided by the embodiment of the present disclosure, by detecting transmission delay time of various data transmission paths between the cache server and the source server, and by configuring data transmission path having the minimum transmission delay time as the shortest data transmission path based on the control center server, it can solve a defect in the prior art that the shortest data transmission path between the cache server and the source server could not be determined by the control center sever, thereby improving data transmission speed.

Embodiments of the present disclosure provide another method for transmitting data. The method can be applied in a cache server, as shown in FIG. 2, the method includes:

201. Detect transmission delay time of multiple data transmission paths between the cache server and a source server.

Among them, the cache server can send detection request packets to the source server by multiple data transmission paths and detect transmission delay time of the multiple data transmission paths.

For the embodiments of the present disclosure, the step 201 can be specifically described as detecting transmission delay time between the various nodes, which are respectively corresponded to multiple data transmission paths between the cache server and the source server.

For example, there are three data transmission paths: data transmission path1, data transmission path2 and data transmission path3 between a cache server and a source server. Nodes corresponded to data transmission path1 are the cache server, the node server1, the node server2, and the source server. Nodes corresponded to data transmission path2 are the cache server, the node server3, and the source server. Nodes corresponded to data transmission path3 are the cache server, the node server4, and the source server. The cache server can obtain detection results thatΔt1 l is the delay time which transmits from the cache server to the node server1, Δt12 is the delay time which transmits from the node server 1to the node server2, Δt13 is the delay time which transmits from the node server 2 to the source server, Δt21 is the delay time which transmits from the cache server to the node server3, Δt22 is the delay time which transmits from the node server3 to the source server, Δt31 is the delay time which transmits from the cache server to the node server4, Δt32 is the delay time which transmits from the node server4 to the source server.

It should be noted that the cache server can transmit the detection result to the control center server to compute transmission delay time of the data transmission path1Δt1, transmission delay time of the data transmission path2Δt2, and transmission delay time of the data transmission path3 Δt3 by equation Δt1=Δt11+Δt12+Δt13, Δt2=Δt21+Δt22 and Δt3=Δt31+Δt32 respectively.

For the embodiments of the present disclosure, by detecting transmission delay time of multiple data transmission paths between a cache server and a source server, link status of various data transmission paths can be available to the control central server and the shortest data transmission path can be determined, thereby data transmission speed can be increased.

202. Transmission delay time of multiple data transmission paths are sent to a control center server.

Further, so that the control center server configures data transmission path having the minimum transmission delay time as the shortest data transmission path between the cache server and the source server.

Among them, the less transmission delay time of data transmission path, the better link status, the faster data transmission speed. For example, there are three data transmission paths: data transmission path1, data transmission path2, data transmission path3, between a cache server and a source server, which correspond to transmission delay timeΔt1, Δt2 and Δt3 respectively. Δt1 is the minimum of Δt1, Δt2 and Δt3, which indicates that speed of data transmission path1 is fastest. It can improve data transmission speed by configuring data transmission path having the minimum transmission delay time as the shortest data transmission path between the cache server and the source server in a control center server.

203. Configuration information of the shortest data transmission is received from the control center.

204. Data transmits with the source server via the shortest data transmission path.

In the method for transmitting data provided by another embodiment of the present disclosure, by detecting transmission delay time of various data transmission paths between a cache server and a source server, and by configuring data transmission path having the minimum transmission delay time as the shortest data transmission path in a control center server, it can solve a defect in the prior art that the shortest data transmission path between the cache server and the source server could not be determined by the control center server, thereby data transmission speed can be increased.

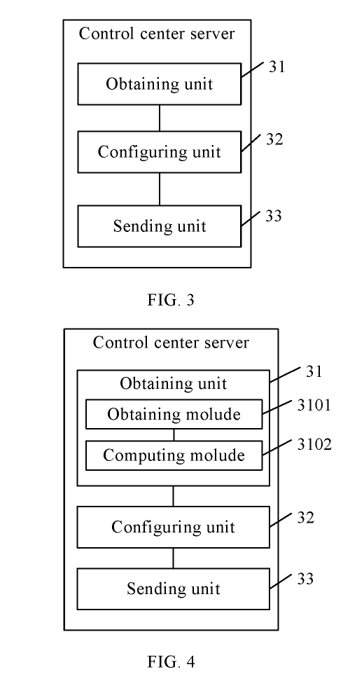

Further, as shown in FIG. 1, an embodiment of the present disclosure provides a control center server, as shown in FIG. 3, the control center server includes: an obtaining unit 31, a configuring unit 32, and a sending unit 33, where

the obtaining unit 31 is configured to obtain transmission delay time of multiple data transmission paths between a cache server and a source server, the said transmission delay time are detected by the cache server. The obtaining unit 31 is the main function module for obtaining transmission delay time of multiple data transmission paths between a cache server and a source server, the said transmission delay time are detected by the cache server.

the configuring unit 32 is configured to configure data transmission path having the minimum transmission delay time as the shortest data transmission path. The configuring unit 32 is the main function for configuring data transmission path having the minimum transmission delay time as the shortest data transmission path.

the sending unit 33 is configured to send configuration information of the shortest data transmission path to the cache server, so that the cache server transmits data to the source server via the shortest data transmission path. The sending unit 33 is the main function module for sending configuration information of the shortest data transmission path to the cache server.

Further, so that data can be transmitted between the cache server and the source server via the shortest data transmission path.

As shown in FIG. 4, the obtaining unit 31 includes: an obtaining module 3101 and a computing module 3102, where

the obtaining module 3101 is configured to obtain transmission delay time between the various nodes, which are respectively corresponded to multiple data transmissions path between a cache server and a source server, the said transmission delay time between the various nodes are detected by the cache server;

the computing module 3102 is configured to compute the said transmission delay time of multiple data transmission paths according to the said transmission delay time between the various nodes.

the computing module 3102 is specifically configured to determine the sum of transmission delay time between the various nodes which are corresponded to each data transmission path as transmission delay time of each data transmission path.

It should be noted that other corresponding descriptions of each functional unit involved in the control center server provided by the embodiment of the present disclosure can refer to corresponding descriptions of the method shown in FIG. 1 which won't be repeated here. Each functional unit used in the embodiment of the present disclosure may be implemented by a hardware processor.

In the control center server provided by the embodiment of the present disclosure, by detecting transmission delay time of various data transmission paths between the cache server and the source server, and by configuring data transmission path having the minimum transmission delay time as the shortest data transmission path based on the control center server, it can solve a defect in the prior art that the shortest data transmission path between the cache server and the source server could not be determined by the control center sever, thereby data transmission speed cam be increased.

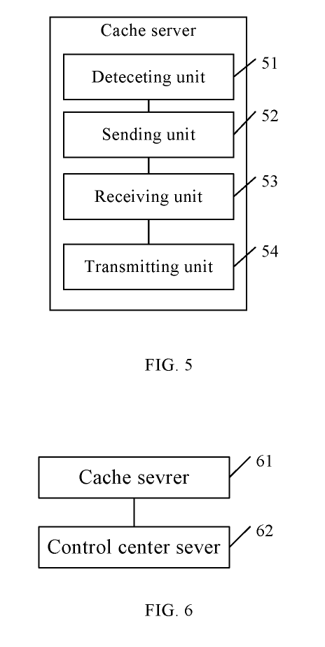

Further, as shown in FIG. 2, an embodiment of the present disclosure provides a cache server, as shown in FIG. 5, the cache server includes: a detecting unit 51, a sending unit 52, a receiving unit 53, and a transmitting unit 54, where

the detecting unit 51 is configured to detect transmission delay time of multiple data transmission paths between the cache server and a source server. The detecting unit 51 is the main function module for detecting transmission delay time of multiple data transmission paths between the cache server and a source server.

the sending unit 52 is configured to send the said transmission delay time to a control center server. The sending unit 52 is the main function module for sending the said transmission delay time to a control center server.

Further, so that the control center server configures data transmission path having the minimum transmission delay time as the shortest data transmission path between the cache server and the source server;

the receiving unit 53 is configured to receive configuration information of the shortest data transmission path from the control center. The receiving unit 53 is the main function module for receiving configuration information of the shortest data transmission path from the control center;

the transmitting unit 54 is configured to transmit data to the source server via the shortest data transmission path. The transmitting unit 54 is the main function module for transmitting data to the source server via the shortest data transmission path.

the sending unit 52 is specifically configured to detect transmission delay time between the various nodes, which are respectively corresponded to multiple data transmission paths between the cache server and a source server.

It should be noted that other corresponding descriptions of each function unit involved in the cache server provided by the embodiment of the present disclosure can refer to corresponding descriptions of the method shown in FIG. 2 which won't be repeated here. Each function unit used in the embodiment of the present disclosure may be implemented by a hardware processor.

In the cache server provided by the embodiment of the present disclosure, by detecting transmission delay time of various data transmission paths between the cache server and the source server, and by configuring data transmission path having the minimum transmission delay time as the shortest data transmission path in the control center server, it can solve a defect in the prior art that the shortest data transmission path between the cache server and the source server could not be determined by the control center sever, thereby data transmission speed can be increased.

Further, an embodiment of the present disclosure provides a system for transmitting data, as shown in FIG. 6, the system includes: a cache server 61 and a control center server 62, where

the cache server 61 is configured to detect transmission delay time of multiple data transmission paths between the cache server and a source server;

the control center server 62 is configured to obtain transmission delay time of multiple data transmission paths, configure data transmission path having the minimum transmission delay time as the shortest data transmission path between the cache server 61 and the source server, and send configuration information of the shortest data transmission path to the cache server 61;

the cache server 61 is also configured to transmit data to the source server based on the shortest data transmission path.

In allusion to the control server, the cache server and the system for transmitting data, it should be noted that functions of each unit module used in the embodiment of the present disclosure may be implemented through a hardware processor.

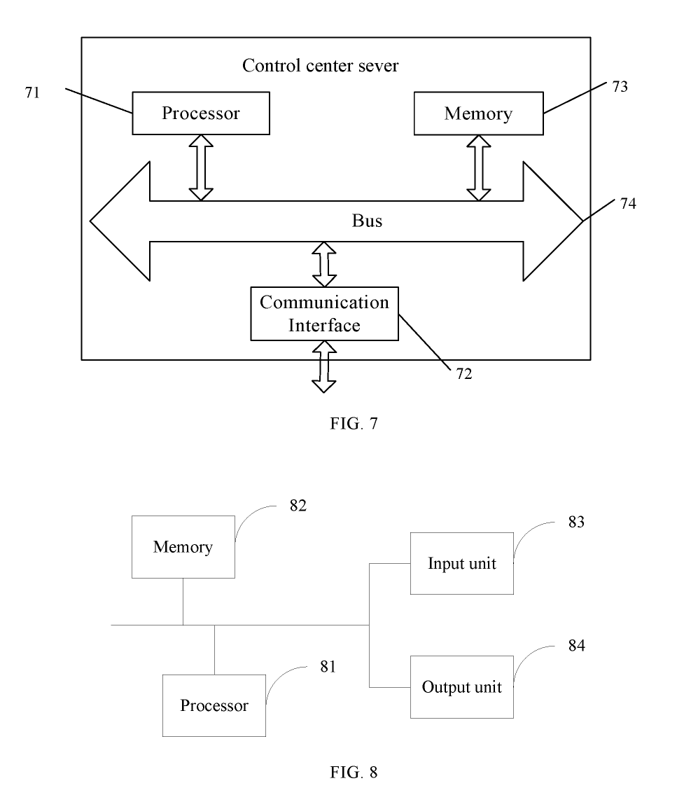

Exemplarily, as shown in FIG. 7, which is a block diagram illustrating a structure of a control center server according to an embodiment of the present disclosure, the control center server includes: a processor 71, a communication Interface 72, a memory 73 and a bus 74. The processor 71, the communications Interface 72 and the memory 73 communicate with each other via the bus 74. The communications Interface 72 may be used for information transmission between the control center server and a cache server. The processor 71 can call logical instructions in the memory 73 to execute the following method: obtaining transmission delay time of multiple data transmission paths between a cache server and a source server, the said transmission delay time are detected by the cache server; configuring data transmission path having the minimum transmission delay time as the shortest data transmission path between the cache server and the source server; sending configuration information of the shortest data transmission path to the cache server, so that data can be transmitted between the cache server and the source server via the shortest data transmission path.

In addition, logical instructions in the memory 73 may be implemented as software functional units which can be stored in a computer-readable storage medium when sold and used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

In the system for transmitting data provided by the embodiment of the present disclosure, by detecting transmission delay time of various data transmission paths between the cache server and the source server, and by configuring data transmission path having the minimum transmission delay time as the shortest data transmission path in the control center server, it can solve a defect in the prior art that the shortest data transmission path between the cache server and the source server could not be determined by the control center sever, thereby data transmission speed can be increased.

Further, an embodiment of the present disclosure further provides a non-transitory computer-readable storage medium storing executable instructions, which can be executed by an electronic device to perform any methods for transmitting data mentioned by embodiments of the present disclosure.

FIG. 8 is a block diagram of an electronic device which is configured to perform the methods for transmitting data according to an embodiment of the present disclosure. As shown in FIG. 8, the device includes:

one or more processors 81 and memory 82. A processor 81 is showed in FIG. 8 for an example.

Device which is configured to perform the methods for transmitting data can also include: input unit 83 and output unit 84.

Processor 81, memory 82, input unit 83 and output unit 84 can be connected by BUS or other methods, and BUS connecting is showed in FIG. 8 for an example.

Memory 82 can be used for storing non-transitory software program, non-transitory computer executable program and modules as a non-transitory computer-readable storage medium, such as corresponding program instructions/modules for the methods for transmitting data mentioned by embodiments of the present disclosure (such as shown in FIG. 3, obtaining unit 31, configuring unit 32 and sending unit 33). Processor 81 performs kinds of functions and transmitting data of the electronic device by executing non-transitory software program, instructions and modules which are stored in memory 82, thereby realizes the methods for transmitting data mentioned by embodiments of the present disclosure.

Memory 82 can include program storage area and data storage area, thereby the operating system and applications required by at least one function can be stored in program storage area and data created by using the device for transmitting data can be stored in data storage area. Furthermore, memory 82 can include high speed Random-access memory (RAM) or non-volatile memory such as magnetic disk storage device, flash memory device or other non-volatile solid state storage devices. In some embodiments, memory 82 can include long-distance setup memories relative to processor 81, which can communicate with the device for transmitting data by networks. The examples of said networks are including but not limited to Internet, Intranet, LAN, mobile Internet and their combinations.

Input unit 83 can be used to receive inputted number, character information and key signals causing user configures and function controls of the device for transmitting data. Output unit 84 can include a display screen or a display device.

The said module or modules are stored in memory 82 and perform the methods for transmitting data when executed by one or more processors 81.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for transmitting data, implemented by a server, comprising:
obtaining transmission delay time of multiple data transmission paths between a cache server and a source server, wherein the said transmission delay time are detected by the cache server;
configuring data transmission path having the minimum transmission delay time as the shortest data transmission path between the cache server and the source server; and
sending configuration information of the shortest data transmission path to the cache server, so that data is transmitted between the cache server and the source server via the shortest data transmission path.

2. The method according to claim 1, wherein the obtaining transmission delay time of multiple data transmission paths between a cache server and a source server comprises:
obtaining transmission delay time between the various nodes, which are respectively corresponded to multiple data transmissions path between a cache server and a source server, wherein the said transmission delay time between the various nodes are detected by the cache server; and
computing the said transmission delay time of multiple data transmission paths according to the said transmission delay time between the various nodes.

3. The method according to claim 2, wherein the computing the said transmission delay time of multiple data transmission paths according to the said transmission delay time between the various nodes comprises:
determining the sum of transmission delay time between the various nodes which are corresponded to each data transmission path as transmission delay time of each data transmission path.

4. An electronic device, comprising:
at least one processor; and
a memory communicably connected with the at least one processor for storing instructions executable by the at least one processor, wherein execution of the instructions by the at least one processor causes the at least one processor to:
obtain transmission delay time of multiple data transmission paths between a cache server and a source server, wherein the said transmission delay time are detected by the cache server;
configure data transmission path having the minimum transmission delay time as the shortest data transmission path between the cache server and the source server; and
send configuration information of the shortest data transmission path to the cache server, so that data is transmitted between the cache server and the source server via the shortest data transmission path.

5. The electronic device according to claim 4, wherein the obtaining transmission delay time of multiple data transmission paths between a cache server and a source server comprises:
obtaining transmission delay time between the various nodes, which are respectively corresponded to multiple data transmissions path between a cache server and a source server, wherein the said transmission delay time between the various nodes are detected by the cache server; and
computing the said transmission delay time of multiple data transmission paths according to the said transmission delay time between the various nodes.

6. The electronic device according to claim 5, wherein the computing the said transmission delay time of multiple data transmission paths according to the said transmission delay time between the various nodes comprises:
determining the sum of transmission delay time between the various nodes which are corresponded to each data transmission path as transmission delay time of each data transmission path.

7. An electronic device, comprising:
at least one processor; and
a memory communicably connected with the at least one processor for storing instructions executable by the at least one processor, wherein execution of the instructions by the at least one processor causes the at least one processor to:
detect transmission delay time of multiple data transmission paths between a cache server and a source server,
send the said transmission delay time to a control center server, so that the control center server configures data transmission path having the minimum transmission delay time as the shortest data transmission path between the cache server and the source server;
receive configuration information of the shortest data transmission path from the control center; and
transmit data to the source server via the shortest data transmission path.

8. The electronic device according to claim 7, wherein the detecting transmission delay time of multiple data transmission paths between a cache server and a source server comprises:
detecting transmission delay time between the various nodes, which are respectively corresponded to multiple data transmission paths between the cache server and a source server.
